(19) United States
(12) Patent Application Publication
(10) Pub. No.: US 2022/0329399 A1
(43) Pub. Date: Oct. 13, 2022

(54) MAXIMUM NUMBER OF NON-OVERLAPPING CCE AND BLIND DECODE PER-MONITORING SPAN

(71) Applicant: TELEFONAKTIEBOLAGET LM ERICSSON (PUBL), STOCKHOLM (SE)

(72) Inventors: Kittipong Kittichokechai, JÄRFÄLLA (SE); Yufei Blankenship, KILDEER, IL (US); Mattias Andersson, SUNDBYBERG (SE)

(21) Appl. No.: 17/633,886

(22) PCT Filed: Aug. 4, 2020
(86) PCT No.: PCT/IB2020/057370

§ 371 Date: Feb. 8, 2022

Related U.S. Application Data
(60) Provisional application No. 62/884,568, filed on Aug. 8, 2019.

(51) Int. Cl. H04L 5/00; H04W 8/24

(52) U.S. Cl. CPC H04L 5/0094; H04W 8/24; H04L 5/0007

(57) ABSTRACT

Embodiments of a method performed by a wireless device are disclosed. In one embodiment, the method comprises providing physical downlink control channel capability information to a base station, where the physical downlink control channel capability information comprises one or more candidate values comprising one or more candidate (X,Y) values or one or more candidate (X, Y, μ) values, where X is a minimum time separation in Orthogonal Frequency Division Multiplexing (OFDM) symbols between the starts of two physical downlink control channel monitoring spans, Y is a maximum length of a physical downlink control channel monitoring span in terms of OFDM symbols, and μ is subcarrier spacing. The method further comprises determining a maximum value. The maximum value is either a maximum number of non-overlapping Control Channel Elements (CCEs) for channel estimation or a maximum number of blind decodes for physical downlink control channel monitoring, per physical downlink control channel monitoring span.

### RELATED APPLICATIONS

This application claims the benefit of U.S. Provisional Patent Application No. 62/884,568, filed Aug. 8, 2019, the disclosure of which is hereby incorporated herein by reference in its entirety.

### TECHNICAL FIELD

The present disclosure relates to physical downlink control channel monitoring in a cellular communications system.

### BACKGROUND

Ultra-Reliable and Low Latency Communication (URLLC) is one of the main use cases of Fifth Generation (5G) New Radio (NR). URLLC has strict requirements on transmission reliability and latency, i.e., 99.9999% reliability within 1 millisecond (ms) one-way latency. In NR Release (Rel) 15, several new features were introduced to support these requirements. For Rel-16, standardization work is focused on further enhancements. This includes Physical Downlink Control Channel (PDCCH) enhancement to support increased PDCCH monitoring capability.

### CORESET Configuration

Control resource sets, also called CORESETs, are configured for User Equipments (UEs) via higher layer parameters. Section 10.1 of Third Generation Partnership Project (3GPP) Technical Specification (TS) 38.213 V15.6.0, section 10.1 reads:

For each DL BWP configured to a UE in a serving cell, a UE can be provided by higher layer signalling with P≤3 CORESETs. For each CORESET, the UE is provided the following by ControlResourceSet:
a CORESET index p, 0≤p<12, by controlResourceSetId;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception in a respective CORESET;
an indication for a presence or absence of a transmission configuration indication (TCI) field for DCI format 1_1 transmitted by a PDCCH in CORESET p, by TCI-PresentInDCI.

Regarding CORESET configuration, 3GPP TS 38.331 V15.6.0 states:
ControlResourceSet

The IE ControlResourceSet is used to configure a time/frequency control resource set (CORESET) in which to search for downlink control information (see TS 38.213 [13], clause 10.1).

### ControlResourceSet Information Element

-- ASN1START
-- TAG-CONTROLRESOURCESET-START

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |

```
      shiftIndex
INTEGER(0..maxNrofPhysicalResourceBlocks−1) OPTIONAL -- Need S
    },
```

| | |
|---|---|
| nonInterleaved | NULL |

},

| | |
|---|---|
| precoderGranularity | ENUMERATED {sameAsREG-bundle, |

allContiguousRBs},

| | |
|---|---|
| tci-StatesPDCCH-ToAddList | SEQUENCE(SIZE (1..maxNrofTCI- |
| StatesPDCCH)) OF TCI-StateId | OPTIONAL, -- Cond NotSIB1-initialBWP |
| tci-StatesPDCCH-ToReleaseList | SEQUENCE(SIZE (1..maxNrofTCI- |
| StatesPDCCH)) OF TCI-StateId | OPTIONAL, -- Cond NotSIB1-initialBWP |
| tci-PresentInDCI | ENUMERATED {enabled} |
| OPTIONAL, -- Need S | |
| pdcch-DMRS-ScramblingID | INTEGER (0..65535) |

OPTIONAL, -- Need S
...
}
-- TAG-CONTROLRESOURCESET-STOP
-- ASN1STOP

### Search Space Configuration

PDCCH search space sets are configured for UEs via higher layer parameters. Section 10.1 of 3GPP TS 38.213 V15.6.0 reads:

For each DL BWP configured to a UE in a serving cell, the UE is provided by higher layers with S≤10 search space sets where, for each search space set from the S search space sets, the UE is provided the following by SearchSpace:
a search space set index s, 0≤s<40, by searchSpaceId
an association between the search space set s and a CORESET p by controlResourceSetId
a PDCCH monitoring periodicity of kₛ slots and a PDCCH monitoring offset of oₛ slots, by monitoringSlotPeriodicityAndOffset
a PDCCH monitoring pattern within a slot, indicating first symbol(s) of the CORESET within a slot for PDCCH monitoring, by monitoringSymbolsWithinSlot
a duration of Tₛ<kₛ slots indicating a number of slots that the search space set s exists by duration
a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
if search space set s is a USS set, an indication by dci-Formats to monitor PDCCH candidates either for DCI format 0_0 and DCI format 1_0, or for DCI format 0_1 and DCI format 1_1

Regarding search space configuration, 3GPP TS 38.331 V15.6.0 states:

SearchSpace

The IE SearchSpace defines how/where to search for PDCCH candidates. Each search space is associated with one ControlResourceSet. For a scheduled cell in the case of cross carrier scheduling, except for nrofCandidates, all the optional fields are absent.

### SearchSpace Information Element

-- ASN1START
-- TAG-SEARCHSPACE-START

| | |
|---|---|
| SearchSpace ::= | SEQUENCE { |
| searchSpaceId | SearchSpaceId, |
| controlResourceSetId | ControlResourceSetId |

OPTIONAL, -- Cond SetupOnly

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |
| } | OPTIONAL, |

-- Cond Setup

| | |
|---|---|
| duration | INTEGER (2..2559) |

OPTIONAL, -- NeedR

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

n6, n8}

| | |
|---|---|
| } | OPTIONAL, |

-- Cond Setup

| | |
|---|---|
| searchSpaceType | CHOICE { |
| common | SEQUENCE { |
| dci-Format0-0-AndFormat1-0 | SEQUENCE { |

...

| | |
|---|---|
| } | OPTIONAL, |

-- Need R

| | |
|---|---|
| dci-Format2-0 | SEQUENCE { |
| nrofCandidates-SFI | SEQUENCE { |
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- NeedR

| | |
|---|---|
| aggregationLevel16 | ENUMERATED {n1, n2} |

```
OPTIONAL -- Need R
        },
        ...
```

| | |
|---|---|
| } | OPTIONAL, |

-- Need R

| | |
|---|---|
| dci-Format2-1 | SEQUENCE { |

...

| | |
|---|---|
| } | OPTIONAL, |

-- Need R

| | |
|---|---|
| dci-Format2-2 | SEQUENCE { |

...

| | |
|---|---|
| } | OPTIONAL, |

-- Need R

| | |
|---|---|
| dci-Format2-3 | SEQUENCE { |
| dummy1 | ENUMERATED {sl1, sl2, sl4, sl5, sl8, |

sl10, sl16, sl20} OPTIONAL, -- Cond Setup

| | |
|---|---|
| dummy2 | ENUMERATED {n1, n2}, |

...

| | |
|---|---|
| } | OPTIONAL |

-- Need R
},

| | |
|---|---|
| ue-Specific | SEQUENCE { |
| dci-Formats | ENUMERATED {formats0-0-And-1- |

```
0, formats0-1-And-1-1},
      ...
    }
```

| | |
|---|---|
| } | OPTIONAL |

-- Cond Setup
}
-- TAG-SEARCHSPACE-STOP
-- ASN1STOP

### Limits of Blind Decode and Non-Overlapping CCE for Channel Estimation

In NR Rel-15, PDCCH monitoring capability is described by the maximum number of blind decodes/monitored PDCCH candidates per slot and the maximum number of non-overlapping Control Channel Elements (CCEs) for channel estimation per slot. These maximum numbers or limits are defined, e.g., in 3GPP TS 38.213, V15.6.0 for a single serving cell as a function of subcarrier spacing values as shown in the tables below.

TABLE 1
Reproduction of Table 10.1-2 of TS 38.213 - Maximum
number M_{PDCCH}^{max, slot, u} of monitored PDCCH candidates
per slot for a DL BWP with SCS configuration μ
ϵ {0, 1, 2, 3} for a single serving cell

| | Maximum number of monitored PDCCH |
|---|---|
| | candidates per slot and per serving |
| μ | cell M_{PDCCH}^{max, slot, u} |
| 0 | 44 |
| 1 | 36 |
| 2 | 22 |
| 3 | 20 |

TABLE 2
Reproduction of Table 10.1-3 of TS 38.213 - Maximum
number C_{PDCCH}^{max, slot, u} of non-overlapped CCEs per
slot for a DL BWP with SCS configuration μ ϵ
{0, 1, 2, 3} for a single serving cell

| | Maximum number of non-overlapped CCEs per slot |
|---|---|
| μ | and per serving cell C_{PDCCH}^{max, slot, u} |
| 0 | 56 |
| 1 | 56 |
| 2 | 48 |
| 3 | 32 |

During NR Rel-15 standardization work, the limits above are first defined for Case 1 (Case 1: one PDCCH monitoring occasion in a slot). There existed discussions on the limit for Case 2 (Case 2: multiple PDCCH monitoring occasions in a slot). However, by the end of Rel-15, the limit for Case 2 remains the same as that of Case 1.

In the Rel-16 enhanced URLLC (eURLLC) study item, it was concluded that the increased limits for PDCCH monitoring capability should be supported at least for non-overlapping CCE for channel estimation. The discussions are currently ongoing in the Rel-16 eURLLC work item.

### UE Capability Signaling for PDCCH Monitoring

Moreover, the UE capability signaling in Rel-15 includes PDCCH monitoring capability for Case 2 in terms of minimum time separation between the start of two PDCCH monitoring spans (X) and maximum length of the spans (Y). As used herein, a PDCCH monitoring span is a duration of time comprising zero or more PDCCH monitoring occasions. The configured search spaces together with the pair (X,Y) then determines the PDCCH monitoring span pattern in a slot. Clarification regarding the monitoring span is given in the agreement made in RAN1 #96bis below.

Agreements:

Update “Feature component” of [Feature Group] FG 3-5b [which is described as “all PDCCH monitoring occasions can be any OFDM symbol(s) of a slot for Case 2 with a span group”] as below:

PDCCH monitoring occasions of FG-3-1, plus additional PDCCH monitoring occasion(s) can be any OFDM symbol(s) of a slot for Case 2, and for any two PDCCH monitoring occasions belonging to different spans, where at least one of them is not the monitoring occasions of FG-3-1, in same or different search spaces, there is a minimum time separation of X OFDM symbols (including the cross-slot boundary case) between the start of two spans, where each span is of length up to Y consecutive OFDM symbols of a slot. Spans do not overlap. Every span is contained in a single slot. The same span pattern repeats in every slot. The separation between consecutive spans within and across slots may be unequal but the same (X, Y) limit must be satisfied by all spans. Every monitoring occasion is fully contained in one span. In order to determine a suitable span pattern, first a bitmap b(l), 0<=l<=13 is generated, where b(l)=1 if symbol l of any slot is part of a monitoring occasion, b(l)=0 otherwise. The first span in the span pattern begins at the smallest l for which b(l)=1. The next span in the span pattern begins at the smallest l not included in the previous span(s) for which b(l)=1. The span duration is max{maximum value of all CORESET durations, minimum value of Y in the UE reported candidate value}except possibly the last span in a slot which can be of shorter duration. A particular PDCCH monitoring configuration meets the UE capability limitation if the span arrangement satisfies the gap separation for at least one (X, Y) in the UE reported candidate value set in every slot, including cross slot boundary.

For the set of monitoring occasions which are within the same span:
Processing one unicast DCI scheduling DL and one unicast DCI scheduling UL per scheduled CC across this set of monitoring occasions for FDD
Processing one unicast DCI scheduling DL and two unicast DCI scheduling UL per scheduled CC across this set of monitoring occasions for TDD
Processing two unicast DCI scheduling DL and one unicast DCI scheduling UL per scheduled CC across this set of monitoring occasions for TDD

The number of different start symbol indices of spans for all PDCCH monitoring occasions per slot, including PDCCH monitoring occasions of FG-3-1, is no more than floor (14/X) (X is minimum among values reported by UE).

The number of different start symbol indices of PDCCH monitoring occasions per slot including PDCCH monitoring occasions of FG-3-1, is no more than 7. The number of different start symbol indices of PDCCH monitoring occasions per half-slot including PDCCH monitoring occasions of FG-3-1 is no more than 4 in SCell.

The supported value sets of (X,Y) for the UE feature group 3-5b are also captured in Section 4.2.7.5 of 3GPP TS 38.306, V15.6.0 as shown below.

| | | | | |
|---|---|---|---|---|
| pdcch-MonitoringAnyOccasionsWithSpanGap | FS | No | No | No |
| Indicates whether the UE supports PDCCH search | | | | |
| space monitoring occasions in any symbol of | | | | |
| the slot with minimum time separation between | | | | |
| two consecutive transmissions of PDCCH with span | | | | |
| up to two OFDM symbols for two OFDM symbols or | | | | |
| span up to three OFDM symbols for four and seven | | | | |
| OFDM symbols. Value set1 indicates the supported | | | | |
| value set (X, Y) is (7, 3), value set2 indicates | | | | |
| the supported value set (X, Y) is (4, 3) and (7, 3) | | | | |
| and value set 3 indicates the supported value set | | | | |
| (X, Y) is (2, 2), (4, 3) and (7, 3). | | | | |

### Limit on the Maximum Number of Non-Overlapping CCEs for Channel Estimation per PDCCH Monitoring Span

In the NR URLLC Rel-16 discussion, there are further discussions on introducing limits on the maximum number of non-overlapping CCEs for channel estimation per PDCCH monitoring span as defined in UE feature 3-5b above. The following agreements were made in RANI #97.

Agreements:

Take the following framework as the working assumption for defining the limit on the maximum number of non-overlapping CCEs for channel estimation per PDCCH monitoring span:
PDCCH monitoring span follows the definition in UE feature 3-5b as a starting point
   FFS whether any modification needed

Agreements:

The per-CC limit on the maximum number of non-overlapping CCEs for channel estimation per PDCCH monitoring span for a certain combination (X, Y, μ) is C
FFS aspects related to UE capability
FFS the limit C on the maximum number of non-overlapping CCEs for channel estimation per PDCCH monitoring span is same or different across different spans within a slot
Example of combinations as shown in the following table:
   FFS the value of C
      Companies are encouraged to report the potential aspects that have impact on the value of C

C

| | | | | | |
|---|---|---|---|---|---|
| X | Y | μ = 0 | μ = 1 | μ = 2 | μ = 3 |

Combination 1
Combination 2
. . .
Note:
The table here doesn't mean increased PDCCH monitoring capability is supported for all SCS.
N/A can be filled in the corresponding cell for the SCS not applicable FFS interaction with Rel-15-based limitation, e.g., whether to increase the limit for PDCCH monitoring case 1 under the increased PDCCH monitoring capability on the maximum number of non-overlapped CCEs per slot for channel estimation

That is, the per-monitoring span limit of the maximum number of non-overlapping CCEs may be fixed in the specification for a certain combination of (X,Y,μ) where the UE only reports (X,Y) as its PDCCH monitoring capability. Or alternatively, the UE reports the per-monitoring span limit together with (X,Y) as part of its PDCCH monitoring capability.

### SUMMARY

Systems and methods related to configuration of physical downlink control channel monitoring are disclosed. In one embodiment, a method performed by a wireless device comprises providing physical downlink control channel capability information to a base station, where the physical downlink control channel capability information comprises one or more candidate values. The one or more candidate values comprise: one or more candidate (X,Y) values where X is a minimum time separation in Orthogonal Frequency Division Multiplexing (OFDM) symbols between starts of two physical downlink control channel monitoring spans and Y is a maximum length of a physical downlink control channel monitoring span in terms of OFDM symbols, or one or more candidate (X,Y,μ) values where X is a minimum time separation in OFDM symbols between the starts of two physical downlink control channel monitoring spans, Y is a maximum length of a physical downlink control channel monitoring span in terms of OFDM symbols, and μ is subcarrier spacing. The method further comprises determining a maximum value (e.g., based on the one or more candidate values). The maximum value is either a maximum number of non-overlapping Control Channel Elements (CCEs) for channel estimation per physical downlink control channel monitoring span or a maximum number of blind decodes for physical downlink control channel monitoring per physical downlink control channel monitoring span. In this manner, a simple and clear method to determine the maximum number of non-overlapping CCEs for channel estimation and/or a maximum number of blind decodes per monitoring span is provided. Embodiments of this method can handle cases where both the per-monitoring span and per-slot limits exist and where multiple sets of the limits are reported or defined.

In one embodiment, the method further comprises using the determined maximum value to perform channel estimation or to perform blind decoding for physical downlink control channel monitoring.

In one embodiment, the method further comprises receiving a search space configuration from the base station. The search space configuration comprises information that, together with the one or more candidate values, defines a physical downlink control channel monitoring span pattern in one or more slots.

In one embodiment, the one or more candidate values comprise two or more candidate values. The two or more candidate values comprises two or more candidate (X,Y) values or two or more candidate (X,Y,μ) values. In one embodiment, determining the maximum value comprises determining the maximum value based on a number of monitoring spans in a slot for a subcarrier spacing of a given downlink bandwidth part in a serving cell of the wireless device. In another embodiment, determining the maximum value comprises determining the maximum value based on a number of non-empty monitoring spans in a slot for a subcarrier spacing of a given downlink bandwidth part in a serving cell of the wireless device.

In another embodiment, for each candidate value of the two or more candidate values, a limiting value is either predefined or signaled for the candidate value, wherein the limiting value is either a per-monitoring span CCE limit or a per-monitoring span blind decode limit. In this embodiment, determining the maximum value comprises selecting the limiting value that is predefined or signaled for one of the two or more candidate values as the maximum value based on one or more rules. In one embodiment, the one or more rules are based on a number of physical downlink control channel monitoring spans in a slot for a subcarrier spacing of a respective downlink bandwidth part of a serving cell of the wireless device. In another embodiment, the one or more rules are based on a number of non-empty physical downlink control channel monitoring spans in a slot for a subcarrier spacing of a respective downlink bandwidth part of a serving cell of the wireless device.

In another embodiment, for each candidate value of the two or more candidate values, a limiting value is either predefined or signaled for the candidate value wherein the limiting value is either a per-monitoring span CCE limit or a per-monitoring span blind decode limit. In this embodiment, determining the maximum value comprises selecting the limiting value that is predefined or signaled for one of the two or more candidate values as the maximum value, the one of the two or more candidate values being an actual value used as determined based on a Control Resource Set (CORESET) configuration of the wireless device and a search space configuration of the wireless device.

In one embodiment, determining the maximum value comprises determining the maximum value based on both a per-monitoring span limit and a per-slot limit. The per-monitoring span limit is either a per-monitoring span CCE limit or a per-monitoring span blind decode limit. The per-slot limit is either a per-slot CCE limit or a per-slot blind decode limit. In one embodiment, determining the maximum value based on both the per-monitoring span limit and the per-slot limit comprises determining an initial maximum value per physical downlink control channel monitoring span, the initial maximum value being an initial maximum number of non-overlapping CCEs for channel estimation per physical downlink control channel monitoring span or an initial maximum number of blind decodes for physical downlink control channel monitoring per physical downlink control channel monitoring span. The initial maximum value per physical downlink control channel monitoring span is the per-monitoring span limit.

In one embodiment, determining the initial maximum value per physical downlink control channel monitoring span comprises determining the initial maximum value per physical downlink control channel monitoring span based on a number of monitoring spans in a slot for a subcarrier spacing of a given downlink bandwidth part in a serving cell of the wireless device.

In one embodiment, determining the initial maximum value per physical downlink control channel monitoring span comprises determining the initial maximum value per physical downlink control channel monitoring span based on a number of non-empty monitoring spans in a slot for a subcarrier spacing of a given downlink bandwidth part in a serving cell of the wireless device.

In one embodiment, for each candidate value of the two or more candidate values, a limiting value is either predefined or signaled for the candidate value wherein the limiting value is either a per-monitoring span CCE limit or a per-monitoring span blind decode limit, and determining the initial maximum value per physical downlink control channel monitoring span comprises selecting the limiting value that is predefined or signaled for one of the two or more candidate values as the maximum value, the one of the two or more candidate values being an actual value used as determined based on a CORESET configuration of the wireless device and a search space configuration of the wireless device.

In one embodiment, determining the maximum value based on both the per-monitoring span limit and the per-slot limit further comprises determining that a sum of the initial maximum value across all physical downlink control channel monitoring spans in a slot is less than the per-slot limit. Determining the maximum value based on both the per-monitoring span limit and the per-slot limit further comprises, upon determining that the sum of the initial maximum value across all physical downlink control channel monitoring spans in the slot is less than the per-slot limit, computing the maximum value as either:

f(N_{CCE/BD_SLOT}, N_{MS}), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or

f(N_{CCE/BD_SLOT}, N′_{MS}), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot.

In one embodiment, determining the maximum value based on both the per-monitoring span limit and the per-slot limit further comprises computing the maximum value as either:

f(N_{CCE/BD_SLOT}, N_{MS}, max(perspan limit)), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or

f(N_{CCE/BD_SLOT}, N′_{MS}, max(perspan limit)), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot.

In one embodiment, two or more per-monitoring span limits are predefined or signaled for the physical downlink control channel monitoring span for each of the one or more candidate values, and the determined maximum value is one of the two or more per-monitoring span limits predefined or signaled for one of the one or more candidate values. In one embodiment, the one of the two or more per-monitoring span limits is one of the two or more per-monitoring span limits that does not lead to physical downlink control channel dropping.

Corresponding embodiments of a wireless device are also disclosed. In one embodiment, a wireless device is adapted to provide physical downlink control channel capability information to a base station. The physical downlink control channel capability information comprising one or more candidate values, wherein the one or more candidate values comprise one or more candidate (X,Y) values where X is a minimum time separation in OFDM symbols between starts of two physical downlink control channel monitoring spans and Y is a maximum length of a physical downlink control channel monitoring span in terms of OFDM symbols, or one or more candidate (X,Y,μ) values where X is a minimum time separation in OFDM symbols between the starts of two physical downlink control channel monitoring spans, Y is a maximum length of a physical downlink control channel monitoring span in terms of OFDM symbols, and μ is subcarrier spacing. The wireless device is further adapted to determine a maximum value, the maximum value being either a maximum number of non-overlapping CCEs for channel estimation per physical downlink control channel monitoring span or a maximum number of blind decodes for physical downlink control channel monitoring per physical downlink control channel monitoring span.

In one embodiment, a wireless device comprises one or more transmitters, one or more receivers, and processing circuitry associated with the one or more transmitters and the one or more receivers. The processing circuitry is configured to cause the wireless device to provide physical downlink control channel capability information to a base station. The physical downlink control channel capability information comprising one or more candidate values, wherein the one or more candidate values comprise one or more candidate (X,Y) values where X is a minimum time separation in OFDM symbols between starts of two physical downlink control channel monitoring spans and Y is a maximum length of a physical downlink control channel monitoring span in terms of OFDM symbols, or one or more candidate (X,Y,μ) values where X is a minimum time separation in OFDM symbols between the starts of two physical downlink control channel monitoring spans, Y is a maximum length of a physical downlink control channel monitoring span in terms of OFDM symbols, and μ is subcarrier spacing. The processing circuitry is further configured to cause the wireless device to determine a maximum value, the maximum value being either a maximum number of non-overlapping CCEs for channel estimation per physical downlink control channel monitoring span or a maximum number of blind decodes for physical downlink control channel monitoring per physical downlink control channel monitoring span.

Embodiments of a method performed by a base station are also disclosed. In one embodiment, a method performed by a base station comprises receiving physical downlink control channel capability information from a wireless device. The physical downlink control channel capability information comprising one or more candidate values, wherein the one or more candidate values comprise one or more candidate (X,Y) values where X is a minimum time separation in OFDM symbols between starts of two physical downlink control channel monitoring spans and Y is a maximum length of a physical downlink control channel monitoring span in terms of OFDM symbols, or one or more candidate (X,Y,μ) values where X is a minimum time separation in OFDM symbols between the starts of two physical downlink control channel monitoring spans, Y is a maximum length of a physical downlink control channel monitoring span in terms of OFDM symbols, and μ is subcarrier spacing. The method further comprises determining a maximum value for the wireless device (e.g., based on the one or more candidate values). The maximum value is either a maximum number of non-overlapping CCEs for channel estimation per physical downlink control channel monitoring span or a maximum number of blind decodes for physical downlink control channel monitoring per physical downlink control channel monitoring span.

In one embodiment, the method further comprises using the determined maximum value.

Corresponding embodiments of a base station are also disclosed. In one embodiment, a base station is adapted to receive physical downlink control channel capability information from a wireless device. The physical downlink control channel capability information comprising one or more candidate values, wherein the one or more candidate values comprise one or more candidate (X,Y) values where X is a minimum time separation in OFDM symbols between starts of two physical downlink control channel monitoring spans and Y is a maximum length of a physical downlink control channel monitoring span in terms of OFDM symbols, or one or more candidate (X,Y,μ) values where X is a minimum time separation in OFDM symbols between the starts of two physical downlink control channel monitoring spans, Y is a maximum length of a physical downlink control channel monitoring span in terms of OFDM symbols, and μ is subcarrier spacing. The base station is further adapted to determine a maximum value for the wireless device (e.g., based on the one or more candidate values). The maximum value is either a maximum number of non-overlapping CCEs for channel estimation per physical downlink control channel monitoring span or a maximum number of blind decodes for physical downlink control channel monitoring per physical downlink control channel monitoring span.

In one embodiment, a base station comprises processing circuitry configured to case the base station to receive physical downlink control channel capability information from a wireless device. The physical downlink control channel capability information comprising one or more candidate values, wherein the one or more candidate values comprise one or more candidate (X,Y) values where X is a minimum time separation in OFDM symbols between starts of two physical downlink control channel monitoring spans and Y is a maximum length of a physical downlink control channel monitoring span in terms of OFDM symbols, or one or more candidate (X,Y,μ) values where X is a minimum time separation in OFDM symbols between the starts of two physical downlink control channel monitoring spans, Y is a maximum length of a physical downlink control channel monitoring span in terms of OFDM symbols, and μ is subcarrier spacing. The processing circuitry is further configured to cause the base station to determine a maximum value for the wireless device (e.g., based on the one or more candidate values). The maximum value is either a maximum number of non-overlapping CCEs for channel estimation per physical downlink control channel monitoring span or a maximum number of blind decodes for physical downlink control channel monitoring per physical downlink control channel monitoring span.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates the operation of a base station (e.g., a New Radio (NR) base station (gNB)) and a User Equipment (UE) in accordance with embodiments of the present disclosure;

FIG. 3 illustrates a monitoring space example in which the UE signals multiple candidate (X,Y) values;

FIG. 4 illustrates another monitoring space example in which the UE signals multiple candidate (X,Y) values and respective limit values;

FIG. 5 illustrates a monitoring example where the UE signals capability of {(2,2),(4,3),(7,3)} and, in slot j+1, only the first and third spans are non-empty spans;

FIGS. 6, 7, and 8 are schematic block diagrams of example embodiments of a radio access node (e.g., a base station); and

FIGS. 9 and 10 are schematic block diagrams of example embodiments of a UE;

FIGS. 11, 12, and 13 illustrate details of step 208 of FIG. 2 in accordance with various embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The UE may report its Physical Downlink Control Channel (PDCCH) monitoring capability as a candidate value set containing multiple candidate values (X,Y), e.g., UE reporting {(2,2),(4,3),(7,3)}, where again X is the minimum time separation between the start of two PDCCH monitoring spans and Y is the maximum length of PDCCH monitoring spans. According to the latest agreement from RAN1 #97, the per-monitoring span limit of maximum number of non-overlapping Control Channel Elements (CCEs) for channel estimation and/or maximum number of blind decodes are expected to be defined or signaled for a certain combination (X,Y,μ), where μ is a subcarrier spacing. It is unclear what the actual maximum number of non-overlapping CCEs for channel estimation and/or the maximum number of blind decodes per monitoring span would be when multiple candidate values (X,Y) are reported.

In some cases, the configuration of PDCCH search space in some slots may not correspond exactly to the level that the UE is most capable of, potentially leading to an underestimated limit for PDCCH monitoring at the UE.

Also, it is unclear what the maximum number of non-overlapping CCEs for channel estimation and/or maximum number of blind decodes would be when there exist both the per-slot and per-monitoring span limits.

In some cases, the UE may be configured with more PDCCH monitoring occasions in the beginning of a slot. Having the same limits for the maximum number of non-overlapping CCEs for channel estimation and/or maximum number of blind decodes per monitoring span for all spans in a slot may, e.g., lead to some PDCCH candidate dropping in the first span. It might therefore be desirable to allow a larger limit for the first monitoring span than the rest of the spans in a slot. In such cases, multiple sets of per-monitoring span limits may be defined or signaled, i.e. one set for the case where the first span has a larger limit, and another set with only one limit value to be applied for all spans. It is not clear how to indicate which set the actual limit would follow.

These unclear aspects need to be addressed to properly introduce a per-monitoring span limit for the maximum number of non-overlapping CCEs for channel estimation and/or a maximum number of blind decodes in the specification.

Certain aspects of the present disclosure and their embodiments may provide solutions to the aforementioned or other challenges. Methods for determining a maximum number of non-overlapping CCEs for channel estimation and/or a maximum number of blind decodes per monitoring span when a UE reports a candidate value set containing one or multiple candidate values (X,Y) are disclosed.

Methods for determining a maximum number of non-overlapping CCEs for channel estimation and/or a maximum number of blind decodes per monitoring span when there exist both the per-span and per-slot limits are also disclosed.

Methods for determining a maximum number of non-overlapping CCEs for channel estimation and/or a maximum number of blind decodes per monitoring span when multiple sets of limits are reported or defined are also disclosed.

Certain embodiments may provide one or more of the following technical advantage(s). The proposed solutions provide simple and clear methods to determine the maximum number of non-overlapping CCEs for channel estimation and/or a maximum number of blind decodes per monitoring span, including solutions to handle cases where both the per-monitoring span and per-slot limits exist and where multiple sets of the limits are reported or defined.

The solutions also ensure that the PDCCH monitoring limit in terms of the maximum number of non-overlapping CCEs for channel estimation and/or the maximum number of blind decodes at UE would correspond well to the PDCCH search space configuration.

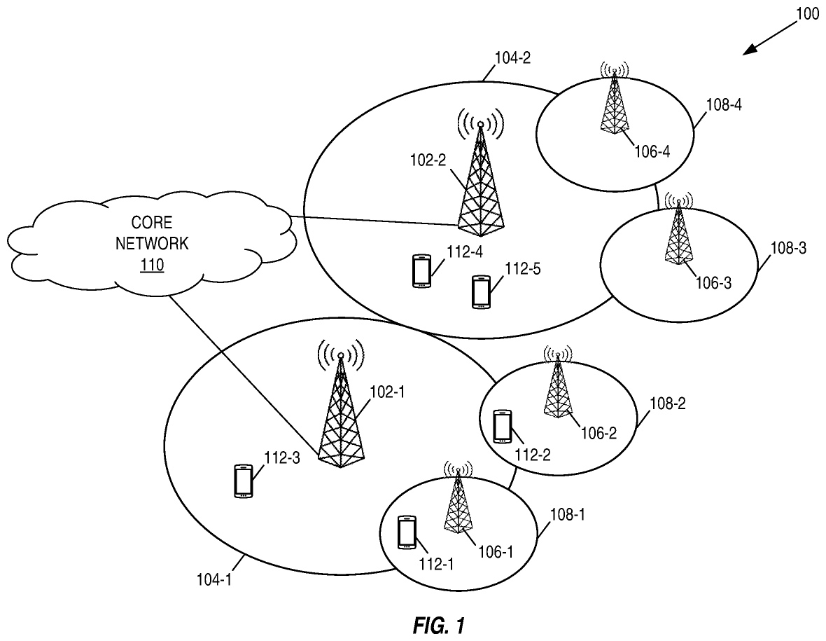

FIG. 1 illustrates one example of a cellular communications system 100 in which embodiments of the present disclosure may be implemented. In the embodiments described herein, the cellular communications system 100 is a 5G system (5GS) including a NR Radio Access Network (RAN); however, the present disclosure is not limited thereto. For example, embodiments described herein may be used in other types of wireless systems such as, e.g., an LTE system. In this example, the RAN includes base stations 102-1 and 102-2, which in 5G NR are referred to as gNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G core (5GC). The base stations 102 (and optionally the low power nodes 106) are connected to the core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

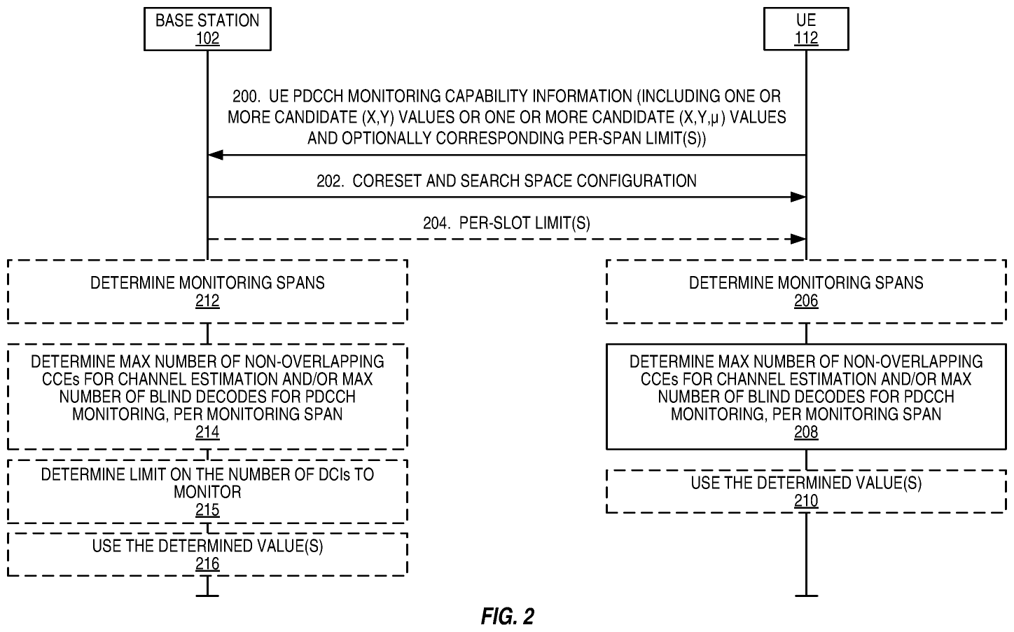

FIG. 2 illustrates the operation of a base station 102 (e.g., a gNB) and a UE 112 in accordance with embodiments of the present disclosure. Note that optional steps are represented with dashed lines or boxes. As illustrated, the UE 112 sends Physical Downlink Control Channel (PDCCH) monitoring capability information to the base station 102 (step 200). The PDCCH monitoring capability information includes one or more candidate (X,Y) values or one or more candidate (X,Y,μ) values. As described herein, X is a minimum time separation in Orthogonal Frequency Division Multiplexing (OFDM) symbols between the start of two monitoring spans (also referred to herein as spans or PDCCH monitoring spans), Y is a maximum length of a monitoring span in terms of consecutive OFDM symbols, and μ is an index of Subcarrier Spacing (SCS) for the respective downlink bandwidth part of the respective serving cell of the UE 112. Also, as used herein the term “(X,Y) value” is a pair or combination of a particular X value and a particular Y value (e.g., (2,2)). Likewise, as used herein, the term “(X,Y,μ) value” is a combination of a particular X value, a particular Y value, and a particular value (e.g., (7,3,1)).

In some embodiments, the PDCCH monitoring capability information includes two or more (X,Y) values or two or more (X,Y,μ) values.

In addition, in some embodiments, the PDCCH monitoring capability information of the UE 112 also includes:

a separate per-span CCE limit (i.e., a limit on the maximum number of non-overlapping CCEs for channel estimation per monitoring span) or a set of per-span CCE limits for each candidate (X,Y) value or each candidate (X,Y,μ) value (or for each of at least some of the candidate values), and/or

a separate per-span blind decode limit (i.e., a limit on the maximum number of blind decodes for PDCCH monitoring per monitoring span) or a set of per-span blind decode limits for each included (X,Y) value or each included (X,Y,μ) value (or for each of at least some of the candidate values).

Note that the per-span CCE limit(s) for each possible (X,Y) value or each possible (X,Y,μ) value may be predefined, e.g., in a corresponding standard. In addition or alternatively, the per-span blind decode limit(s) for each possible (X,Y) value or each possible (X,Y,μ) value may be predefined, e.g., in a corresponding standard.

The base station 102 provides a Control Resource Set (CORESET) and search space configuration to the UE 112 (step 202). Note that the configured search spaces together with the candidate (X,Y) values or the candidate (X,Y,μ) values indicated by the UE 112 in step 200 determine the PDCCH monitoring span pattern in a slot.

In some embodiments, the base station 102 also provides:

a per-slot CCE limit or a set of per-slot CCE limits for each possible (X,Y) value (or each candidate (X,Y) value of the UE 112) or each possible (X,Y,μ) value (or each candidate X,Y,μ) value of the UE 112); and/or

a per-slot blind decode limit or a set of per-slot blind decode limits for each possible (X,Y) value (or each candidate (X,Y) value of the UE 112) or each possible (X,Y,μ) value (or each candidate X,Y,μ) value of the UE 112) (step 204).

In some embodiments, the per-slot CCE limit(s) for each possible/candidate (X,Y) value or each possible/candidate (X,Y,μ) value may be predefined, e.g., in a corresponding standard and/or the per-slot blind decode limit(s) for each possible/candidate (X,Y) value or each possible/candidate (X,Y,μ) value may be predefined, e.g., in a corresponding standard.

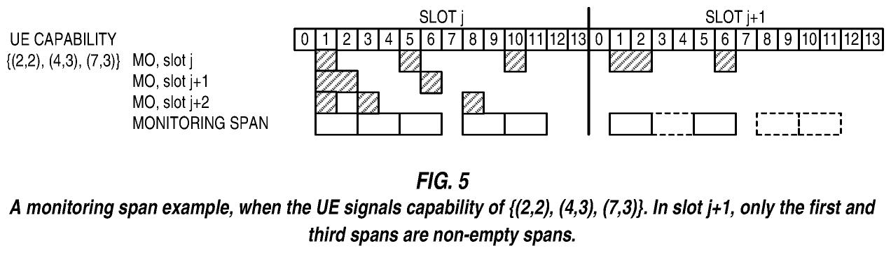

At the UE 112, the UE 112 optionally determines the PDCCH monitoring span pattern in one or more slots based the search space configuration of the UE 112 (step 206). For example, the manner in which the UE 112 determines the PDCCH monitoring span pattern in a slot is given in the agreement regarding FG 3-5b described above. When the UE 112 reports multiple candidate (X,Y) values (or likewise when the UE 112 reports multiple candidate (X,Y,μ) values), then the minimum value of Y in the reported set of candidate (X,Y) values is used to determine the span duration according to the agreement that “The span duration is max{maximum value of all CORESET durations, minimum value of Y in the UE reported candidate value *set*} except possibly the last span in a slot which can be of shorter duration.” Then the minimum value of X in the reported set of candidate (X,Y) values determines the minimum span gap according to the agreement that “A particular PDCCH monitoring configuration meets the UE capability limitation if the span arrangement satisfies the gap separation for at least one (X, Y) in the UE reported candidate value set in every slot, including cross slot boundary.” One example of how the monitoring span pattern is determined is given in FIG. 5 where the candidate value set {(2,2),(4,3),(7,3)} is reported. It can be seen that the monitoring span pattern (including the dashed spans) satisfies the span duration of max{maximum value of all CORESET durations, minimum value of Y in the UE reported candidate value *set*}=max{2,2} =2, and the minimum span gap of 2 symbols.

Optionally, the UE 112 also determines a limit on the number of DCIs to monitor for the set of PDCCH monitoring occasions within a monitoring span (step 207). Additional details regarding this step are provided below.

The UE 112 determines the maximum number of non-overlapping CCEs for channel estimation per monitoring span and/or the maximum number of blind decodes for PDCCH monitoring per monitoring span (step 208). Note that several embodiments are described below for how the UE 112 determines the maximum number of non-overlapping CCEs for channel estimation per monitoring span and/or the maximum number of blind decodes for PDCCH monitoring per monitoring span. Any of those embodiments can be used herein in step 208. As described below in detail, embodiments are disclosed for determining the maximum number of non-overlapping CCEs for channel estimation per monitoring span and/or the maximum number of blind decodes per monitoring span when the UE 112 indicates two or more candidate (X,Y) values or two or more candidate (X,Y,μ) values in the PDCCH monitoring information in step 200. Other embodiments are disclosed below for determining the maximum number of non-overlapping CCEs for channel estimation per monitoring span and/or the maximum number of blind decodes per monitoring span when there exist both the per-span and per-slot limits. Other embodiments are disclosed below for determining the maximum number of non-overlapping CCEs for channel estimation per monitoring span and/or the maximum number of blind decodes per monitoring span when multiple sets of limits are reported or defined.

The UE 112 optionally uses the determined values (i.e., the determined maximum number of non-overlapping CCEs for channel estimation per monitoring span and/or the determined maximum number of blind decodes for PDCCH monitoring per monitoring span, as determined in step 208), e.g., to perform channel estimation and/or blind decoding for PDCCH monitoring (step 210). For example, the UE 112 may determine the maximum number of non-overlapping CCEs for channel estimation and/or the maximum number of blind decodes per monitoring span so that it can skip some PDCCH monitoring once the limit is reached.

Optionally, the base station 102 also determines the PDCCH monitoring span pattern in one or more slots based on the search space configuration of the UE 112 (step 212). The base station 102 may determine the PDCCH monitoring span pattern in the same way as described above with respect to step 206. The base station 102 optionally determines the maximum number of non-overlapping CCEs for channel estimation per monitoring span and/or the maximum number of blind decodes for PDCCH monitoring per monitoring span (step 214). Note that several embodiments are described below for how the base station 102 determines the maximum number of non-overlapping CCEs for channel estimation per monitoring span and/or the maximum number of blind decodes for PDCCH monitoring per monitoring span. Any of those embodiments can be used herein in step 214. As described below in detail, embodiments are disclosed for determining the maximum number of non-overlapping CCEs for channel estimation per monitoring span and/or a maximum number of blind decodes per monitoring span when the UE 112 indicates two or more candidate (X,Y) values or two or more candidate (X,Y,μ) values in the PDCCH monitoring information in step 200. Other embodiments are disclosed below for determining the maximum number of non-overlapping CCEs for channel estimation per monitoring span and/or the maximum number of blind decodes per monitoring span when there exist both the per-span and per-slot limits. Other embodiments are disclosed below for determining the maximum number of non-overlapping CCEs for channel estimation per monitoring span and/or the maximum number of blind decodes per monitoring span when multiple sets of limits are reported or defined.

The base station 102 optionally determines a limit on the number of DCIs to monitor for the set of PDCCH monitoring occasions within a monitoring span (step 215). Additional details regarding this step are provided below.

The base station 102 optionally uses the determined values (i.e., the determined maximum number of non-overlapping CCEs for channel estimation per monitoring span and/or the determined maximum number of blind decodes for PDCCH monitoring per monitoring span, as determined in step 208) to perform one or more actions (step 216). For example, in some cases, when the method is not coupled with the PDCCH search space configuration, the base station 102 could also use the knowledge of the maximum number of non-overlapping CCEs for channel estimation and/or the maximum number of blind decodes per monitoring span to configure the search space properly with respect to UE PDCCH monitoring capability.

Now, the description turns to the details of some example embodiments of the present disclosure.

### Determination of Maximum Number of Non-Overlapping CCEs for Channel Estimation Per-Monitoring Span

Here, embodiments are described where PDCCH monitoring limits (e.g., maximum number of blind decodes and maximum number of non-overlapping CCEs for channel estimation, respectively) per monitoring span are determined based on the number of monitoring spans or non-empty monitoring spans in a slot for the SCS of the given downlink Bandwidth Part (BWP) in the serving cell. These embodiments may be used in step 208 of FIG. 2.

Methods are described using the non-overlapping CCE limit as an example, while the same principle can be applied to the Blind Decoding (BD) limit, as explained later. Here the CCE limit refers to the maximum number of non-overlapping CCEs over which a UE is expected to perform channel estimation during a given time unit, for the given downlink BWP and the SCS, for the purpose of detecting PDCCH candidates.

Cases are considered where the per-monitoring span limit of the maximum number of non-overlapping CCEs is either 1) fixed in the specification for a certain combination of (X,Y,μ) where the UE only reports (X,Y) as its PDCCH monitoring capability, or 2) reported together with (X,Y) as part of its PDCCH monitoring capability (e.g., in step 200 of FIG. 2).

For the first case, the per-monitoring span limit for maximum number of non-overlapping CCEs may, as an example, be defined (e.g., in the specification) as in the table below. The UE reports one of the candidate values sets {(2,2),(4,3),(7,3)}, {(4,3),(7,3)}, and {(7,3)}.

TABLE 3
CCE limit per-monitoring span C_{j, μ} for (X, Y) combination j and SCS index μ

| | | | Per-span CCE limit | | | |
|---|---|---|---|---|---|---|
| | | | μ = 0 | μ = 1 | μ = 2 | μ = 3 |
| | X | Y | (SCS = 15 kHz) | (SCS = 30 kHz) | (SCS = 60 kHz) | (SCS = 120 kHz) |
| Combination 1 | 2 | 2 | C_{1, μ = 0} | C_{1, μ = 1} | C_{1, μ = 2} | C_{1, μ = 3} |
| Combination 2 | 4 | 3 | C_{2, μ = 0} | C_{2, μ = 1} | C_{2, μ = 2} | C_{2, μ = 3} |
| Combination 3 | 7 | 3 | C_{3, μ = 0} | C_{3, μ = 1} | C_{3, μ = 2} | C_{3, μ = 3} |

For the second case, the UE reports the per-monitoring span limit for the maximum number of non-overlapping CCEs together with (X,Y), i.e., the candidate value set may be, e.g.:

{(2,2,C_{1,μ}), (4,3,C_{2, μ}),(7,3 C_{3, μ})}, μ=0,1,2,3 or,

{(4,3,C_{2, μ}),(7,3 C_{3, μ})}, μ=0,1,2,3 or,

{(7,3 C_{3, 82} )}, μ=0,1,2,3.

While in this discussion three combinations of (X,Y) are assumed, in general, other combinations of (X,Y) may be used in addition to, or in place of, the three combinations illustrated. For example, the other combinations of (X,Y) may include one or more of the following:

(2,1)

(3,1)

(3,2)

(3,3)

(4,1)

(4,2)

(5,1)

(5,2)

(5,3)

(14,3).

For each of the combinations listed above, the CCE limit per monitoring span is provided correspondingly, either by defining C_{j, μ} as shown in Table 3 above, or signaled as part of the capability (Xⱼ, Yⱼ, C_{j, μ}).

In one non-limiting embodiment, the maximum number of non-overlapping CCEs for channel estimation is determined based on the number of monitoring spans in a slot for the SCS of the given downlink BWP in the serving cell.

For example,

If there are four to seven monitoring spans in a slot, the maximum number of non-overlapping CCEs per span for any slot follows the per-span limit corresponding to (X,Y)=(2,2). That is, C_{1,μ} if the CCE limit is defined according to Table 3.

If there are three monitoring spans in a slot, the maximum number of non-overlapping CCEs per span for any slot follows the per-span limit corresponding to (X,Y)=(4,3). That is, C_{2, μ} if the CCE limit is defined according to Table 3.

If there are two monitoring spans in a slot, the maximum number of non-overlapping CCEs per span for any slot follows the per-span limit corresponding to (X,Y)=(7,3). That is, C_{3, μ} if the CCE limit is defined according to Table 3.

If there is one monitoring span in a slot, the maximum number of non-overlapping CCEs per span for any slot follows the new or existing per-slot limit. In Release (Rel) 15, the per-slot limit is provided in the specifications for the so-called case 1-1, which refers to PDCCH monitoring on up to three OFDM symbols at the beginning of a slot. According to the preferred embodiment, the per-slot limit is also used as the per-span limit corresponding to (X,Y)=(7,3).

In the following, an illustration of how the determination procedure is applied for a given SCS is provided.

Example 1-A. CCE limit is defined in the specification: Consider an example where the CCE limit per monitoring span is fixed in the specification as in the table below.

| | X | Y | Per-span CCE limit |
|---|---|---|---|
| Combination 1 | 2 | 2 | C_{1, μ} |
| Combination 2 | 4 | 3 | C_{2, μ} |
| Combination 3 | 7 | 3 | C_{3, μ} |

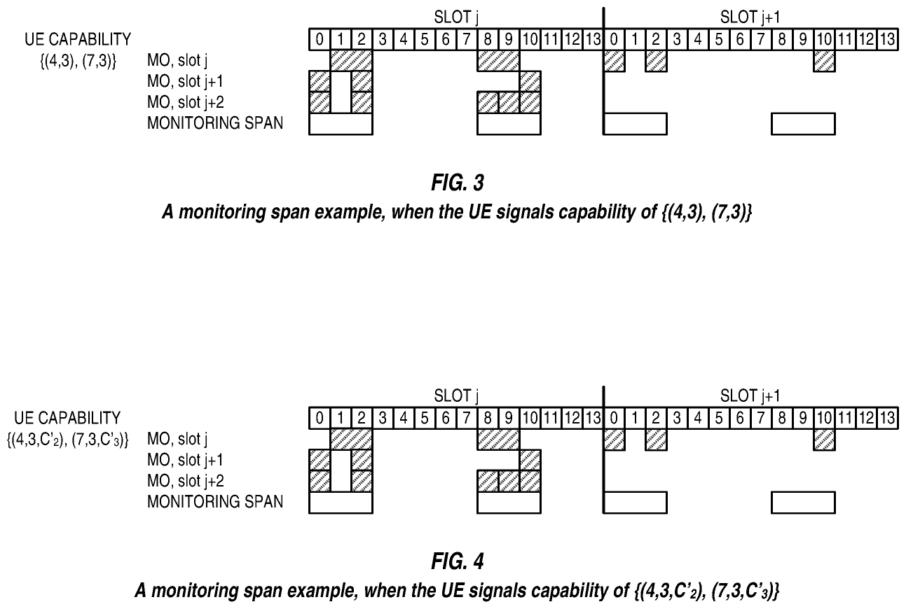

FIG. 3 illustrates a monitoring space example, when the UE signals capability of {(4,3),(7,3)}. With PDCCH CORESET and search space set configuration as in FIG. 3, there are two monitoring spans in a slot. Although the UE signals both (4,3) and (7,3), the maximum number of non-overlapping CCEs for channel estimation per monitoring span is determined to be C₃ since there are two monitoring spans in a slot corresponding to (7,3) capability.

Example 1-B. CCE limit is signaled as part of monitoring capability: In another example, the UE signals (X,Y) together with the per-span limit as shown in FIG. 4. Specifically, FIG. 4 illustrates a monitoring span example when the UE signals capability of {(4,3,C′₂),(7,3,C′₃)}. Similarly, in this case, since there are two monitoring spans in a slot, the maximum number of non-overlapping CCEs for channel estimation per monitoring span is determined to be C′₃.

In another version of this embodiment, when a new candidate value (X,Y) is defined, e.g., (3,2) or (3,3), the method above can be adjusted to take such new candidate value into account.

In this embodiment, each slot has the same CCE limit, regardless of the layout of the monitoring occasions in a specific slot.

In one non-limiting embodiment, the maximum number of non-overlapping CCEs for channel estimation is determined based on the number of non-empty monitoring spans in a slot for the SCS of the given downlink BWP in the serving cell.

For example,

If there are four to seven non-empty monitoring spans in a slot, the maximum number of non-overlapping CCEs per span for that slot follows the per-span limit corresponding to (X,Y)=(2,2).

If there are three non-empty monitoring spans in a slot, the maximum number of non-overlapping CCEs per span for that slot follows the per-span limit corresponding to (X,Y) =(4,3).

If there are two non-empty monitoring spans in a slot, the maximum number of non-overlapping CCEs per span for that slot follows the per-span limit corresponding to (X,Y)=(7,3).

If there is one non-empty monitoring span in a slot, the maximum number of non-overlapping CCEs per span for that slot follows the new/existing per-slot limit. According to the preferred embodiment, the per-slot limit is also used as the per-span limit corresponding to (X,Y)=(7,3).

FIG. 5 illustrates a monitoring example where the UE signals capability of {(2,2),(4,3),(7,3)} and, in slot j+1, only the first and third spans are non-empty spans. As illustrated below, with PDCCH configuration as in FIG. 5, there are five non-empty monitoring spans in slot j, while on slot j+1 there are only two non-empty spans. Although the UE signaled all candidates (X,Y) of (2,2), (4,3), and (7,3), the maximum number of non-overlapping CCEs for channel estimation per monitoring span is determined to be C₁ for slot j and C₃ for slot j+1 since there are five and two non-empty monitoring spans in slot j and j+1, respectively.

Similarly, the UE may signal (X,Y) together with the per-span limit, i.e., {{2,2, C′₁},(4,3, C′₂),(7,3, C′₃)}. With the PDCCH configurations and span pattern as in FIG. 5, the maximum number of non-overlapping CCEs for channel estimation per monitoring span is determined to be C′₁ for slot j and C′₃ for slot j+1.

That is, if C₁<C₃ or C′₁<C′₃, the UE has a higher CCE limit per monitoring span in slot j+1 since it does not need to perform PDCCH blind decoding on those empty monitoring spans.

In this embodiment, each slot may not have the same CCE limit. For a specific slot, the CCE limit varies according to the number of non-empty (versus empty) monitoring spans in the slot, which is determined by the layout of the monitoring occasions in the given slot.

In one non-limiting embodiment, the maximum number of non-overlapping CCEs for channel estimation is determined by:

Step 1: Both the gNB and UE determine the actual (X_{actual}, Y_{actual}) to assume from (a) the set of (X,Y) reported as UE capability, and (b) the CORESET and search space set configuration by the gNB.
Using FIG. 3 as an example, the UE reported the set of capabilities with two (X,Y): {(4,3), (7,3)}. When combining the reported UE capability with the CORESET and search space set configuration by the gNB, the gNB and the UE both determine that (X_{actual}, Y_{actual})=(7,3).

Step 2: The CCE limit corresponding to (X_{actual}, Y_{actual}) is then adopted by both the UE and gNB.
Using FIG. 3 as an example, both the gNB and the UE adopt C_{3,μ} which corresponds to combination 3: (X_{actual}, Y_{actual})=(7,3)
   In this embodiment, each slot has the same CCE limit regardless of the layout of the monitoring occasions in a specific slot.

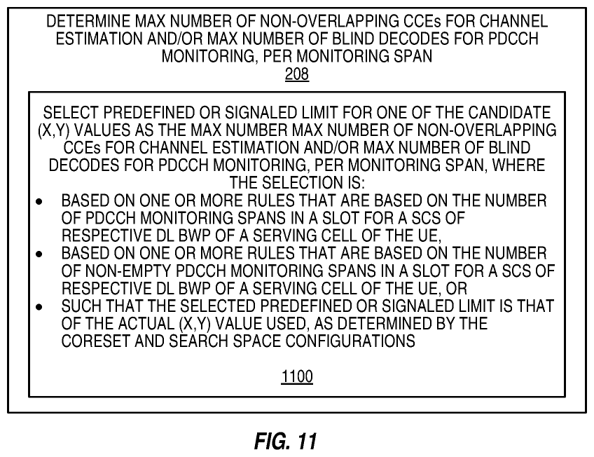

FIG. 11 illustrates the details of step 208 of FIG. 2 in accordance with an example of Embodiments 1-1 through 1-3. As illustrated, the UE 112 selects a predefined or signaled limiting value (e.g., a per-monitoring span CCE limit or a per-monitoring span blind decode limit) for one of the candidate (X,Y) values (or one of the candidate (X,Y,μ) values) as the maximum value to be used (step 1100). As discussed above, in Embodiment 1-1, the UE 112 selects one of the predefined or signaled limiting values for the candidate (X,Y) values based on the number of monitoring spans in a slot for a subcarrier spacing of a given downlink BWP in a serving cell of the UE 112. In Embodiment 1-2, the UE 112 selects one of the predefined or signaled limiting values for the candidate (X,Y) values based on the number of non-empty monitoring spans in a slot for a subcarrier spacing of a given downlink BWP in a serving cell of the UE 112. In Embodiment 1-3, the UE 112 selects the predefined or signaled limiting value for the actual (X,Y) value, as determined based on the CORESET and search space set configuration of the UE 112.

### Determination of Maximum Number of Non-Overlapping CCE for Channel Estimation Per-Monitoring Span When there Exist Both the Per-Span and Per-Slot Limits

Here, embodiments are described where both the per-span and per-slot limits for the maximum number of non-overlapping CCEs for channel estimation exist. Again, these embodiments may be used in step 208 of FIG. 2.

Let N_{CCE_SLOT} be the CCE limit per slot for the given SCS. This value may be predefined, e.g., by a standard, or indicated by the UE as part of the capability signaling. Let N_{CCE_MS} be the CCE limit per monitoring span as determined based on any of the methods in Embodiments 1-1, 1-2, and 1-3 described above. Let N_{MS} be the number of monitoring spans in a slot. Denote N′_{MS,j} as the number of non-empty monitoring spans in the slot j.

In one non-limiting embodiment, the maximum number of non-overlapping CCEs for channel estimation is determined based on any of the methods in Embodiments 1-1, 1-2, and 1-2 described above and the per-slot limit.

When the total maximum number of CCEs in a slot calculated from N_{CCE_MS} is less than the per-slot limit, i.e., the summation of N_{CCE_MS} across all spans in a slot lead to a smaller value than the per-slot limit N_{CCE_SLOT} then the actual maximum number of non-overlapping CCEs per span in each slot is determined by

$${N}_{CCE \_ MS , actual} = floor ( \frac{{N}_{CCE \_ SLOT}}{{N}_{MS}} ) .$$

Alternatively, the maximum number of non-overlapping CCEs per span for the j-th slot takes into account the non-empty monitoring span in the j-th slot, and the actual maximum number of non-overlapping CCEs per span in j-th slot is:

$${N}_{CCE \_ MS , j , actual} = floor ( \frac{{N}_{CCE \_ SLOT}}{{N}_{MS , j}^{′}} ) .$$

To reconcile the difference between the per-slot limit and per-monitoring-span limit, functions other than “floor(.)” can be used to obtain the maximum number of non-overlapping CCEs per span. For example, “round(.)” and “ceil(.)” functions can be used. That is,

$${N}_{CCE \_ MS , actual} = round ( \frac{{N}_{CCE \_ SLOT}}{{N}_{MS}} ) and {N}_{CCE \_ MS , j , actual} = round ( \frac{{N}_{CCE \_ SLOT}}{{N}_{MS , j}^{′}} ) .$$

$$Or , {N}_{CCE \_ MS , actual} = ceil ( \frac{{N}_{CCE \_ SLOT}}{{N}_{MS}} ) and {N}_{CCE \_ MS , j , actual} = ceil ( \frac{{N}_{CCE \_ SLOT}}{{N}_{MS , j}^{′}} ) .$$

In one non-limiting embodiment, if the summation of the maximum number of non-overlapping CCEs per span of all spans in a slot lead to a smaller value than the slot limit, then the maximum number of non-overlapping CCEs per span in each slot is determined by

$${N}_{CCE \_ MS} + floor ( \frac{{N}_{CCE \_ SLOT} - ( {N}_{MS} * {N}_{CCE \_ MS} )}{{N}_{MS}} ) , or$$

$${N}_{CCE \_ MS} + floor ( \frac{{N}_{CCE \_ SLOT} - ( {N}_{MS , j}^{′} * {N}_{CCE \_ MS} )}{{N}_{MS , j}^{′}} ) ,$$

where N_{CCE_MS} is the maximum CCE per span determined according to any of the methods in the embodiments described above.

In one non-limiting embodiment, if the summation of the maximum number of non-overlapping CCEs per span of all spans in a slot lead to a smaller value than the slot limit, then the maximum number of non-overlapping CCEs per span for the first span in the slot is determined by

N_{CCE_MS}+N_{CCE_SLOT}−(N_{MS}*N_{CCE_MS}), or

N_{CCE_MS}+N_{CCE_SLOT}−(N′_{MS,j}*N_{CCE_MS}),

where N_{CCE_MS} is the maximum CCE per span determined according to any of the methods in the embodiments described above. The rest of the spans follow the limit N_{CCE_MS}.

In one non-limiting embodiment, when there are multiple reported candidate (X,Y) values or multiple signaled per-span limit candidates as in FIGS. 3 through 5, the maximum number of non-overlapping CCEs per span is determined as

$$min ( max ( perspan limit candidates ) , floor ( \frac{{N}_{CCE \_ SLOT}}{{N}_{MS}} ) ) , or$$

$$min ( max ( perspan limit candidates ) , floor ( \frac{{N}_{CCE \_ SLOT}}{{N}_{MS , j}^{′}} ) ) .$$

For example, let the slot limit be N_{CCE_SLOT}=C₀. With the PDCCH configuration and span pattern in FIG. 3, the maximum number of non-overlapping CCEs per span is determined as

$$min ( max ( {C}_{2} , {C}_{3} ) , floor ( \frac{{C}_{0}}{2} ) ) .$$

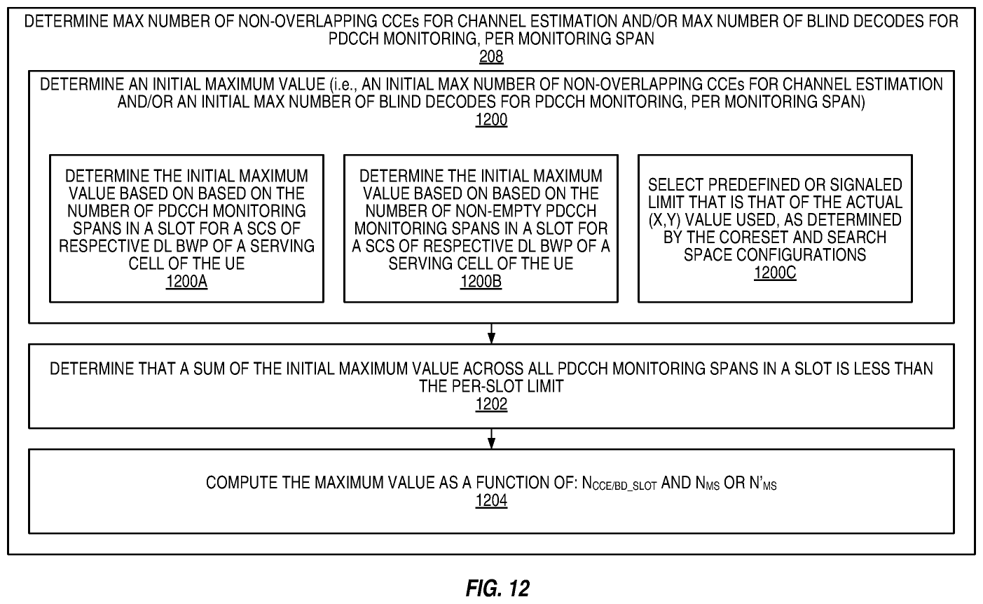

FIG. 12 illustrates an example of step 208 of FIG. 2 in accordance with some embodiments of the present disclosure in which both the per-span and per-slot limits for the maximum number of non-overlapping CCEs for channel estimation exist, as described above. As illustrated, the UE 112 determines an initial maximum value per physical downlink control channel monitoring span (1200). The initial maximum value is either an initial maximum number of non-overlapping CCEs for channel estimation per PDCCH monitoring span or an initial maximum number of blind decodes for PDCCH monitoring per PDCCH monitoring span. The initial maximum value may be determined using any of the embodiments described above for determining the maximum number of non-overlapping CCEs for channel estimation per PDCCH monitoring span or an initial maximum number of blind decodes for PDCCH monitoring per PDCCH monitoring span. In other words, in one embodiment, the UE 112 determines the initial maximum value based on the number of PDCCH monitoring spans in a slot for a subcarrier spacing of a given DL BWP in a serving cell of the UE 112 (step 1200A). In another embodiment, the UE 112 determines the initial maximum value based on the number of non-empty PDCCH monitoring spans in a slot for a subcarrier spacing of a given DL BWP in a serving cell of the UE 112 (step 1200B). In another embodiment, for each candidate (X,Y) value, a limiting value is either predefined or signaled for the candidate (X,Y) value. The limiting value is either a per-monitoring span CCE limit or a per-monitoring span blind decode limit. The UE 112 determines the initial maximum value by selecting the limiting value that is predefined or signaled for one of the candidate (X,Y) values that is determined to be the actual (X,Y) value to be used by the UE 112, based on the CORESET and search space configurations of the UE 112 (step 1200C).

The UE 112 determines that a sum of the initial maximum value across all PDCCH monitoring spans in a slot is less than the per-slot limit (step 1202). Upon determining that the sum of the initial maximum value across all PDCCH monitoring spans in the slot is less than the per-slot limit, the UE 112 computes the maximum value as either:

f(N_{CCE/BD_SLOT}, N_{MS}), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or

f(N_{CCE/BD_SLOT}, N′_{MS}), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot (step 1204).

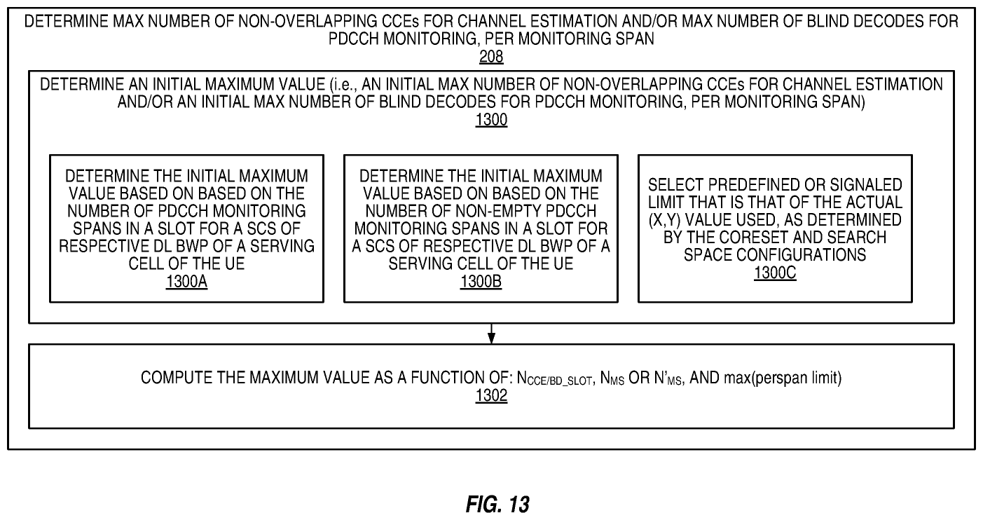

FIG. 13 illustrates an example of step 208 of FIG. 2 in accordance with some embodiments of the present disclosure in which both the per-span and per-slot limits for the maximum number of non-overlapping CCEs for channel estimation exist, as described above. As illustrated, the UE 112 determines an initial maximum value per physical downlink control channel monitoring span (1300). The initial maximum value is either an initial maximum number of non-overlapping CCEs for channel estimation per PDCCH monitoring span or an initial maximum number of blind decodes for PDCCH monitoring per PDCCH monitoring span. The initial maximum value may be determined using any of the embodiments described above for determining the maximum number of non-overlapping CCEs for channel estimation per PDCCH monitoring span or an initial maximum number of blind decodes for PDCCH monitoring per PDCCH monitoring span. In other words, in one embodiment, the UE 112 determines the initial maximum value based on the number of PDCCH monitoring spans in a slot for a subcarrier spacing of a given DL BWP in a serving cell of the UE 112 (step 1300A). In another embodiment, the UE 112 determines the initial maximum value based on the number of non-empty PDCCH monitoring spans in a slot for a subcarrier spacing of a given DL BWP in a serving cell of the UE 112 (step 1300B). In another embodiment, for each candidate (X,Y) value, a limiting value is either predefined or signaled for the candidate (X,Y) value. The limiting value is either a per-monitoring span CCE limit or a per-monitoring span blind decode limit. The UE 112 determines the initial maximum value by selecting the limiting value that is predefined or signaled for one of the candidate (X,Y) values that is determined to be the actual (X,Y) value to be used by the UE 112, based on the CORESET and search space configurations of the UE 112 (step 1300C).

### Determination of Maximum Number of Non-Overlapping CCE for Channel Estimation Per-Monitoring Span When Multiple Sets of CCE Limits are Signaled or Defined

In some cases, the UE signals (e.g., in the PDCCH monitoring capability information of step 200 of FIG. 2) multiple sets of per-span limit values for each (X,Y,μ) or multiple values of per-span limits are defined for each (X,Y,μ). For example, two sets are signaled or defined, one set for the case where the first span has a larger limit, and another set with only one limit value to be applied for all spans. For example, two sets are defined in the table below.

| | | |
|---|---|---|
| X | Y | Per-span CCE limit |

| | | | | |
|---|---|---|---|---|
| Combination 1 | 2 | 2 | C₁ for first | C₁ for all spans |
| | | | span, and D₁ | |
| | | | for the | |
| | | | remaining | |
| | | | spans | |
| Combination 2 | 4 | 3 | C₂ for first | C₂ for all spans |
| | | | span, and D₂ | |
| | | | for the | |
| | | | remaining | |
| | | | spans | |
| Combination 3 | 7 | 3 | C₃ for first | C₃ for all spans |
| | | | span, and D₃ | |
| | | | for the | |
| | | | remaining | |
| | | | spans | |

The embodiments in this section can also be used in step 208 of FIG. FIG. 2.

In one non-limiting embodiment, the maximum number of non-overlapping CCEs per span is determined according to the above Embodiments. When multiple sets of CCE limits are signaled or defined, which set to apply depends on the limit values and PDCCH search space configuration.

If there is at least one set where the PDCCH configuration does not lead to PDCCH candidate dropping (i.e., the total number of CCEs to perform channel estimation on in a span exceeds the maximum value), the UE follows the limit of such set.

For a given PDCCH configuration, if both sets lead to PDCCH candidate dropping, the UE follows the limit of the default set. The default set is defined in the specification to be one of the possible sets.

### Determination of Maximum Number of Blind Decodes Per-Monitoring Span

All above embodiments can be similarly applied (e.g., in step 208 of FIG. FIG. 2) to determine the maximum number of blind decodes per monitoring span where the per-span limit and per-slot limits are defined for blind decoding.

### Limit on DCI to Monitor in a Monitoring Span

Limits on Downlink Control Information (DCI) to monitor for the set of monitoring occasions within the same span can be defined.

In one embodiment, the DCI monitor limits defined for FG 3-5b can be reused:

1(a) Processing one unicast DCI scheduling downlink and one unicast DCI scheduling uplink per scheduled component carrier across this set of monitoring occasions for Frequency Division Duplexing (FDD).

1(b) Processing one unicast DCI scheduling downlink and two unicast DCI scheduling uplink per scheduled component carrier across this set of monitoring occasions for Time Division Duplexing (TDD).

1(c) Processing two unicast DCI scheduling downlink and one unicast DCI scheduling uplink per scheduled component carrier across this set of monitoring occasions for TDD.

In another embodiment, the DCI monitor limits can be defined for a half slot. For example,

2(a) For each half slot, processing one unicast DCI scheduling downlink and one unicast DCI scheduling uplink per scheduled component carrier across the monitoring occasions in the given half slot for FDD.

2(b) For each half slot, processing one unicast DCI scheduling downlink and two unicast DCI scheduling uplink per scheduled component carrier across the monitoring occasions in the given half slot for TDD.

2(c) For each half slot, processing two unicast DCI scheduling downlink and one unicast DCI scheduling uplink per scheduled component carrier across the monitoring occasions in the given half slot for TDD.

In another embodiment, the DCI monitor limits can depend on the downlink Semi-Persistent Scheduling (SPS) configuration and the uplink configured grant configuration. For example,

If more than N_{DL,SPS,thrsh} downlink SPS processes are configured, then 2(a) limit applies. Otherwise, 1(a) limit applies.

If more than N_{UL,CG,thrsh} uplink configured grant processes are configured, then 2(b) and 2(c) limit applies. Otherwise, 1(b) and 1(c) limit applies.

### Additional Aspects

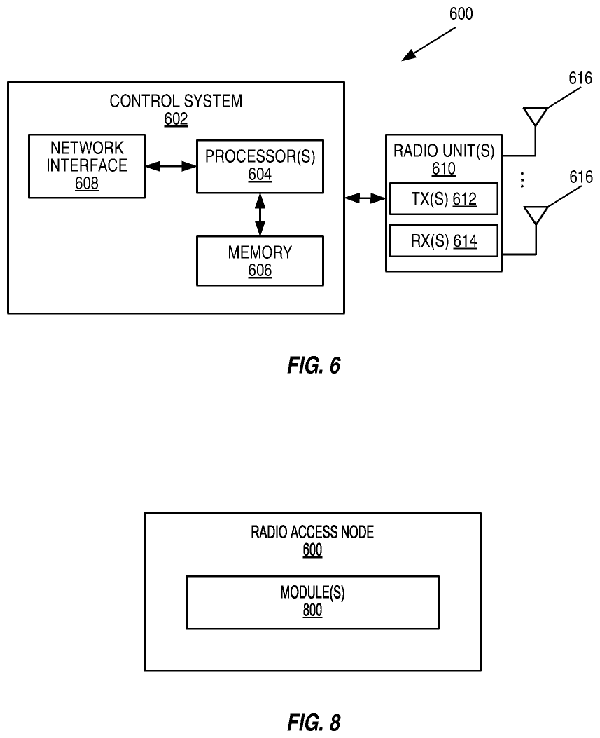

FIG. FIG. 6 is a schematic block diagram of a radio access node 600 according to some embodiments of the present disclosure. The radio access node 600 may be, for example, a base station 102 or 106. As illustrated, the radio access node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, the radio access node 600 includes one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of a radio access node 600 as described herein (e.g., one or more functions of a base station 102 or gNB as described above, e.g., in relation to FIG. 2 and/or to any of the various “Embodiments” described above). In some embodiments, the function(s) are implemented in software that is stored, e.g., in the memory 606 and executed by the one or more processors 604.

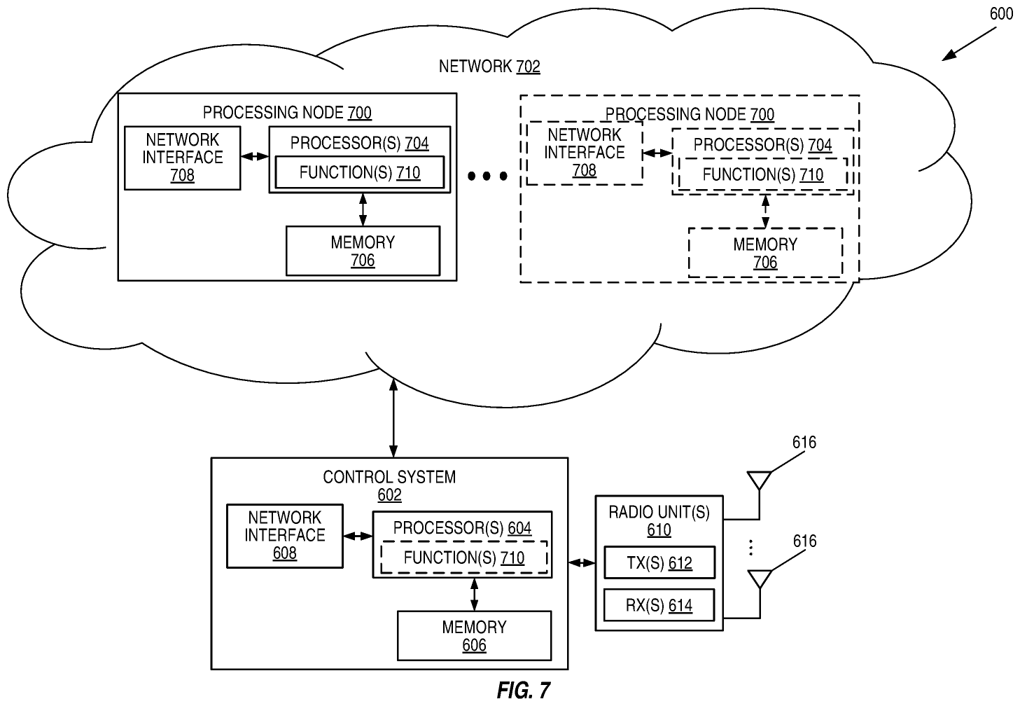

FIG. 7 is a schematic block diagram that illustrates a virtualized embodiment of the radio access node 600 according to some embodiments of the present disclosure. This discussion is equally applicable to other types of network nodes. Further, other types of network nodes may have similar virtualized architectures.

As used herein, a “virtualized” radio access node is an implementation of the radio access node 600 in which at least a portion of the functionality of the radio access node 600 (e.g., one or more functions of a base station 102 or gNB as described above, e.g., in relation to FIG. 2 and/or to any of the various “Embodiments” described above) is implemented as a virtual component(s) (e.g., via a virtual machine(s) executing on a physical processing node(s) in a network(s)). As illustrated, in this example, the radio access node 600 includes the control system 602 that includes the one or more processors 604 (e.g., CPUs, ASICs, FPGAs, and/or the like), the memory 606, and the network interface 608 and the one or more radio units 610 that each includes the one or more transmitters 612 and the one or more receivers 614 coupled to the one or more antennas 616, as described above. The control system 602 is connected to the radio unit(s) 610 via, for example, an optical cable or the like. The control system 602 is connected to one or more processing nodes 700 coupled to or included as part of a network(s) 702 via the network interface 608. Each processing node 700 includes one or more processors 704 (e.g., CPUs, ASICs, FPGAs, and/or the like), memory 706, and a network interface 708.

In this example, functions 710 of the radio access node 600 described herein (e.g., one or more functions of a base station 102 or gNB as described above, e.g., in relation to FIG. 2 and/or to any of the various “Embodiments” described above) are implemented at the one or more processing nodes 700 or distributed across the control system 602 and the one or more processing nodes 700 in any desired manner In some particular embodiments, some or all of the functions 710 of the radio access node 600 described herein are implemented as virtual components executed by one or more virtual machines implemented in a virtual environment(s) hosted by the processing node(s) 700. As will be appreciated by one of ordinary skill in the art, additional signaling or communication between the processing node(s) 700 and the control system 602 is used in order to carry out at least some of the desired functions 710. Notably, in some embodiments, the control system 602 may not be included, in which case the radio unit(s) 610 communicate directly with the processing node(s) 700 via an appropriate network interface(s).

In some embodiments, a computer program including instructions which, when executed by at least one processor, causes the at least one processor to carry out the functionality of radio access node 600 or a node (e.g., a processing node 700) implementing one or more of the functions 710 of the radio access node 600 (e.g., one or more functions of a base station 102 or gNB as described above, e.g., in relation to FIG. 2 and/or to any of the various “Embodiments” described above) in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the radio access node 600 according to some other embodiments of the present disclosure. The radio access node 600 includes one or more modules 800, each of which is implemented in software. The module(s) 800 provide the functionality of the radio access node 600 described herein (e.g., one or more functions of a base station 102 or gNB as described above, e.g., in relation to FIG. 2 and/or to any of the various “Embodiments” described above). This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

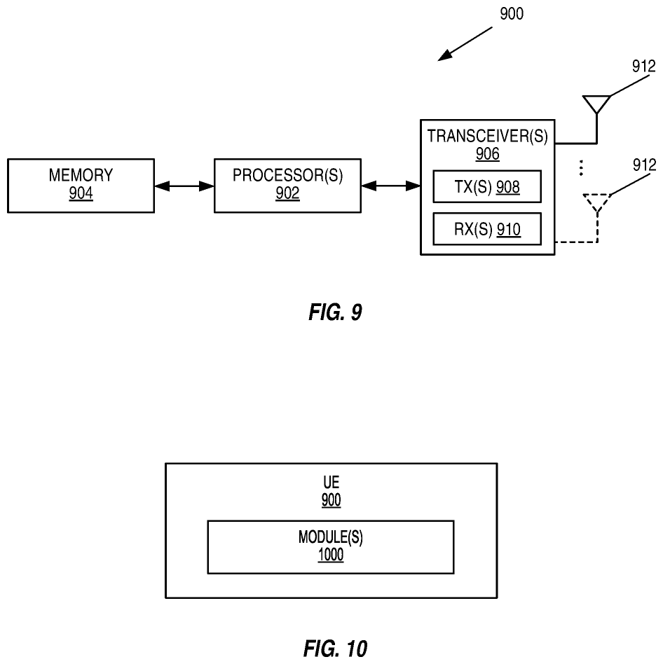

FIG. 9 is a schematic block diagram of a UE 900 according to some embodiments of the present disclosure. As illustrated, the UE 900 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the UE 900 described above (e.g., one or more functions of a UE 112 or UE as described above, e.g., in relation to FIG. 2 and/or to any of the various “Embodiments” described above) may be fully or partially implemented in software that is, e.g., stored in the memory 904 and executed by the processor(s) 902. Note that the UE 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the UE 900 and/or allowing output of information from the UE 900), a power supply (e.g., a battery and associated power circuitry), etc.

In some embodiments, a computer program including instructions which, when executed by at least one processor, causes the at least one processor to carry out the functionality of the UE 900 according to any of the embodiments described herein (e.g., one or more functions of a UE 112 or UE as described above, e.g., in relation to FIG. 2 and/or to any of the various “Embodiments” described above) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the UE 900 according to some other embodiments of the present disclosure. The UE 900 includes one or more modules 1000, each of which is implemented in software. The module(s) 1000 provide the functionality of the UE 900 described herein (e.g., one or more functions of a UE 112 or UE as described above, e.g., in relation to FIG. 2 and/or to any of the various “Embodiments” described above).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments are as follows:

### Group A Embodiments

Embodiment 1: A method performed by a wireless device, the method comprising:

providing (200) physical downlink control channel capability information to a base station, the physical downlink control channel capability information comprising one or more candidate values wherein the one or more candidate values comprise:
one or more candidate (X,Y) values, where X is a minimum time separation in Orthogonal Frequency Division Multiplexing, OFDM, symbols between starts of two physical downlink control channel monitoring spans and Y is a maximum length of a physical downlink control channel monitoring span in terms of OFDM symbols; or
one or more candidate (X,Y,μ) values, where X is a minimum time separation in OFDM symbols between the starts of two physical downlink control channel monitoring spans and Y is a maximum length of a physical downlink control channel monitoring span in terms of OFDM symbols; and

determining (208) a maximum value, the maximum value being either:
a maximum number of non-overlapping Control Channel Elements, CCEs, for channel estimation per physical downlink control channel monitoring span; or
a maximum number of blind decodes for physical downlink control channel monitoring per physical downlink control channel monitoring span.

Embodiment 2: The method of embodiment 1 further comprising receiving (202) a search space configuration from the base station, the search space configuration comprising information that, together with the one or more candidate values, defines a physical downlink control channel monitoring span pattern in one or more slots.

Embodiment 3: The method of embodiment 1 or 2 wherein the one or more candidate values comprise two or more candidate values, the two or more candidate values comprising two or more candidate (X,Y) values or two or more candidate (X,Y,μ) values.

Embodiment 4: The method of embodiment 3 wherein:

for each candidate value of the two or more candidate values, a limiting value is either predefined or signaled for the candidate value, wherein the limiting value is either a per-monitoring span CCE limit or a per-monitoring span blind decode limit; and

determining the maximum value comprises:
selecting the limiting value that is predefined or signaled for one of the two or more candidate values as the maximum value based on one or more rules.

Embodiment 5: The method of embodiment 4 wherein the one or more rules are based on a number of physical downlink control channel monitoring spans in a slot for a subcarrier spacing (e.g., a subcarrier spacing of a respective downlink bandwidth part of a serving cell of the wireless device).

Embodiment 6: The method of embodiment 4 wherein the one or more rules are based on a number of non-empty physical downlink control channel monitoring spans in a slot for a subcarrier spacing (e.g., a subcarrier spacing of a respective downlink bandwidth part of a serving cell of the wireless device).

Embodiment 7: The method of embodiment 3 wherein:

for each candidate value of the two or more candidate values, a limiting value is either predefined or signaled for the candidate value wherein the limiting value is either a per-monitoring span CCE limit or a per-monitoring span blind decode limit; and

determining the maximum value comprises:
selecting the limiting value that is predefined or signaled for one of the two or more candidate values as the maximum value, the one of the two or more candidate values being an actual value used as determined based on Control Resource Set, CORESET, and search space configurations of the wireless device.

Embodiment 8: The method of any one of embodiments 1 to 3 wherein determining the maximum value comprises determining the maximum value based on both a per-monitoring span limit and a per-slot limit, wherein the per-monitoring span limit is either a per-monitoring span CCE limit or a per-monitoring span blind decode limit and the per-slot limit is either a per-slot CCE limit or a per-slot blind decode limit.

Embodiment 9: The method of embodiment 8 wherein determining the maximum value based on both the per-monitoring span limit and the per-slot limit comprises determining an initial maximum value per physical downlink control channel monitoring span in accordance with any one of embodiments 4 through 7, the initial maximum value being an initial maximum number of non-overlapping CCEs for channel estimation per physical downlink control channel monitoring span or an initial maximum number of blind decodes for physical downlink control channel monitoring per physical downlink control channel monitoring span, wherein the initial maximum value per physical downlink control channel monitoring span is the per-monitoring span limit.

Embodiment 10: The method of embodiment 9 wherein determining the maximum value based on both the per-monitoring span limit and the per-slot limit further comprises:

determining that a sum of the initial maximum value across all physical downlink control channel monitoring spans in a slot is less than the per-slot limit; and

upon determining that the sum of the initial maximum value across all physical downlink control channel monitoring spans in the slot is less than the per-slot limit, computing the maximum value as either:
f(N_{CCE/BD_SLOT}, N_{MS}), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or
f(N_{CCE/BD_SLOT}, N′_{MS}), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot.

Embodiment 11: The method of embodiment 9 wherein determining the maximum value based on both the per-monitoring span limit and the per-slot limit further comprises:

computing the maximum value as either:
f(N_{CCE/BD_SLOT}, N′_{MS}), max(per−span limit)), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or
f(N_{CCE/BD_SLOT}, N′_{MS}), max(per−span limit)), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot.

Embodiment 12: The method of any one of embodiments 1 to 11 wherein different per-monitoring span limits are defined for each of two or more sets of physical downlink control channel monitoring spans for each of at least one of the one or more candidate values, and determining the maximum value comprises determining the maximum value for each monitoring span based on the per-monitoring span limit for the respective set of physical downlink control channel monitoring spans.

### Group B Embodiments

Embodiment 13: A method performed by a base station, the method comprising:

receiving (200) physical downlink control channel capability information from a wireless device, the physical downlink control channel capability information comprising one or more candidate values wherein the one or more candidate values comprise:
one or more candidate (X,Y) values, where X is a minimum time separation in Orthogonal Frequency Division Multiplexing, OFDM, symbols between starts of two physical downlink control channel monitoring spans and Y is a maximum length of a physical downlink control channel monitoring span in terms of OFDM symbols; or
one or more candidate (X,Y,μ) values, where X is a minimum time separation in OFDM symbols between the starts of two physical downlink control channel monitoring spans and Y is a maximum length of a physical downlink control channel monitoring span in terms of OFDM symbols; and

determining (214) a maximum value, the maximum value being either:
a maximum number of non-overlapping Control Channel Elements, CCEs, for channel estimation per physical downlink control channel monitoring span; or
a maximum number of blind decodes for physical downlink control channel monitoring per physical downlink control channel monitoring span.

### Group C Embodiments

Embodiment 14: A wireless device comprising: processing circuitry configured to perform any of the steps of any of the Group A embodiments; and power supply circuitry configured to supply power to the wireless device.

Embodiment 15: A base station comprising: processing circuitry configured to perform any of the steps of any of the Group B embodiments; and power supply circuitry configured to supply power to the base station.

Embodiment 16: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

At least some of the following abbreviations may be used in this disclosure. If there is an inconsistency between abbreviations, preference should be given to how it is used above. If listed multiple times below, the first listing should be preferred over any subsequent listing(s).

3GPP Third Generation Partnership Project

5G Fifth Generation

5GC Fifth Generation Core

5GS Fifth Generation System

AMF Access and Mobility Management Function

AP Access Point

ASIC Application Specific Integrated Circuit

AUSF Authentication Server Function

BD Blind Decoding

BWP Bandwidth Part

CCE Control Channel Element

CORESET Control Resource Set

CPU Central Processing Unit

DCI Downlink Control Information

DSP Digital Signal Processor

eNB Enhanced or Evolved Node B

eURLLC Enhanced Ultra-Reliable and Low Latency Communication

FDD Frequency Division Duplexing

FPGA Field Programmable Gate Array

gNB New Radio Base Station

HSS Home Subscriber Server

LTE Long Term Evolution

MME Mobility Management Entity

ms Millisecond

MTC Machine Type Communication

NEF Network Exposure Function

NF Network Function

NR New Radio

NRF Network Function Repository Function

NSSF Network Slice Selection Function

OFDM Orthogonal Frequency Division Multiplexing

OTT Over-the-Top

PCF Policy Control Function

PDCCH Physical Downlink Control Channel

P-GW Packet Data Network Gateway

RAM Random Access Memory

RAN Radio Access Network

Rel Release

ROM Read Only Memory

RRH Remote Radio Head

SCEF Service Capability Exposure Function

SCS Subcarrier Spacing

SMF Session Management Function

SPS Semi-Persistent Scheduling

TDD Time Division Duplexing

TS Technical Specification

UDM Unified Data Management

UE User Equipment

UPF User Plane Function

URLLC Ultra-Reliable and Low Latency Communication

Those skilled in the art will recognize improvements and modifications to the embodiments of the present disclosure. All such improvements and modifications are considered within the scope of the concepts disclosed herein.

1. A method performed by a wireless device, the method comprising:
providing physical downlink control channel capability information to a base station, the physical downlink control channel capability information comprising one or more candidate values, wherein the one or more candidate values comprise:
one or more candidate (X,Y) values, where X is a minimum time separation in Orthogonal Frequency Division Multiplexing, OFDM, symbols between starts of two physical downlink control channel monitoring spans and Y is a maximum length of a physical downlink control channel monitoring span in terms of OFDM symbols; or
one or more candidate (X,Y,μ) values, where X is a minimum time separation in OFDM symbols between the starts of two physical downlink control channel monitoring spans, Y is a maximum length of a physical downlink control channel monitoring span in terms of OFDM symbols, and μ is subcarrier spacing; and
determining a maximum value based on the one or more candidate values, the maximum value being either:
a maximum number of non-overlapping Control Channel Elements, CCEs, for channel estimation per physical downlink control channel monitoring span; or
a maximum number of blind decodes for physical downlink control channel monitoring per physical downlink control channel monitoring span.

2. The method of claim 0 further comprising using the determined maximum value to perform channel estimation or to perform blind decoding for physical downlink control channel monitoring.

3. The method of claim 1 further comprising receiving a search space configuration from the base station, the search space configuration comprising information that, together with the one or more candidate values, defines a physical downlink control channel monitoring span pattern in one or more slots.

4. The method of claim 1 wherein the one or more candidate values comprise two or more candidate values, the two or more candidate values comprising two or more candidate (X,Y) values or two or more candidate (X,Y,μ) values.

5. The method of claim 4 wherein determining the maximum value comprises determining the maximum value based on a number of monitoring spans in a slot for a subcarrier spacing of a given downlink bandwidth part in a serving cell of the wireless device.

6. The method of claim 0 wherein determining the maximum value comprises determining the maximum value based on a number of non-empty monitoring spans in a slot for a subcarrier spacing of a given downlink bandwidth part in a serving cell of the wireless device.

7. The method of claim 0 wherein:
for each candidate value of the two or more candidate values, a limiting value is either predefined or signaled for the candidate value, wherein the limiting value is either a per-monitoring span CCE limit or a per-monitoring span blind decode limit; and
determining the maximum value comprises selecting the limiting value that is predefined or signaled for one of the two or more candidate values as the maximum value based on one or more rules.

8. The method of claim 0 wherein the one or more rules are based on a number of physical downlink control channel monitoring spans in a slot for a subcarrier spacing of a respective downlink bandwidth part of a serving cell of the wireless device.

9. The method of claim 0 wherein the one or more rules are based on a number of non-empty physical downlink control channel monitoring spans in a slot for a subcarrier spacing of a respective downlink bandwidth part of a serving cell of the wireless device.

10. The method of claim 0 wherein:
for each candidate value of the two or more candidate values, a limiting value is either predefined or signaled for the candidate value wherein the limiting value is either a per-monitoring span CCE limit or a per-monitoring span blind decode limit; and
determining the maximum value comprises selecting the limiting value that is predefined or signaled for one of the two or more candidate values as the maximum value, the one of the two or more candidate values being an actual value used as determined based on a Control Resource Set, CORESET, configuration of the wireless device and a search space configuration of the wireless device.

11. The method of claim 1 wherein:
determining the maximum value comprises determining the maximum value based on both a per-monitoring span limit and a per-slot limit;
the per-monitoring span limit is either a per-monitoring span CCE limit or a per-monitoring span blind decode limit; and
the per-slot limit is either a per-slot CCE limit or a per-slot blind decode limit.

12. The method of claim 0 wherein determining the maximum value based on both the per-monitoring span limit and the per-slot limit comprises:
determining an initial maximum value per physical downlink control channel monitoring span, the initial maximum value being an initial maximum number of non-overlapping CCEs for channel estimation per physical downlink control channel monitoring span or an initial maximum number of blind decodes for physical downlink control channel monitoring per physical downlink control channel monitoring span;
wherein the initial maximum value per physical downlink control channel monitoring span is the per-monitoring span limit.

13. The method of claim 12 wherein determining the initial maximum value per physical downlink control channel monitoring span comprises determining the initial maximum value per physical downlink control channel monitoring span based on a number of monitoring spans in a slot for a subcarrier spacing of a given downlink bandwidth part in a serving cell of the wireless device.

14. The method of claim 12 wherein determining the initial maximum value per physical downlink control channel monitoring span comprises determining the initial maximum value per physical downlink control channel monitoring span based on a number of non-empty monitoring spans in a slot for a subcarrier spacing of a given downlink bandwidth part in a serving cell of the wireless device.

15. The method of claim 4 wherein:
for each candidate value of the two or more candidate values, a limiting value is either predefined or signaled for the candidate value wherein the limiting value is either a per-monitoring span CCE limit or a per-monitoring span blind decode limit; and
determining the initial maximum value per physical downlink control channel monitoring span comprises selecting the limiting value that is predefined or signaled for one of the two or more candidate values as the maximum value, the one of the two or more candidate values being an actual value used as determined based on a Control Resource Set, CORESET, configuration of the wireless device and a search space configuration of the wireless device.

16. The method of claim 12 wherein determining the maximum value based on both the per-monitoring span limit and the per-slot limit further comprises:
determining that a sum of the initial maximum value across all physical downlink control channel monitoring spans in a slot is less than the per-slot limit; and
upon determining that the sum of the initial maximum value across all physical downlink control channel monitoring spans in the slot is less than the per-slot limit, computing the maximum value as either:
f(N_{CCE/BD_SLOT}, N_{MS}), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or
f(N_{CCE/BD_SLOT}, N′_{MS}), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot.

17. The method of claim 12 wherein determining the maximum value based on both the per-monitoring span limit and the per-slot limit further comprises:
computing the maximum value as either:
f(N_{CCE/BD_SLOT}, N_{MS}, max(perspan limit)), where N_{CCE/BD_SLOT} is the per-slot limit on the initial maximum number of non-overlapping CCEs or the per-slot limit on the initial maximum number of blind decodes, and N_{MS} is the number of physical downlink control channel monitoring spans in the slot; or
f(N_{CCE/BD_SLOT}, N′_{MS}, max(perspan limit)), where N_{CCE/BD_SLOT} is the per-slot limit on the initial maximum number of non-overlapping CCEs or the per-slot limit on the initial maximum number of blind decodes, and N′_{MS} is a number of non-empty physical downlink control channel monitoring spans in the slot.

18. The method of claim 1 wherein two or more per-monitoring span limits are predefined or signaled for the physical downlink control channel monitoring span for each of the one or more candidate values, and the determined maximum value is one of the two or more per-monitoring span limits predefined or signaled for one of the one or more candidate values.

19. The method of claim 0 wherein the one of the two or more per-monitoring span limits is one of the two or more per-monitoring span limits that does not lead to physical downlink control channel dropping.

20-21. (canceled)

22. A wireless device comprising:
one or more transmitters;
one or more receivers; and
processing circuitry associated with the one or more transmitters and the one or more receivers, the processing circuitry configured to cause the wireless device to:
provide physical downlink control channel capability information to a base station, the physical downlink control channel capability information comprising one or more candidate values, wherein the one or more candidate values comprise:
one or more candidate (X,Y) values, where X is a minimum time separation in Orthogonal Frequency Division Multiplexing, OFDM, symbols between starts of two physical downlink control channel monitoring spans and Y is a maximum length of a physical downlink control channel monitoring span in terms of OFDM symbols; or
one or more candidate (X,Y,μ) values, where X is a minimum time separation in OFDM symbols between the starts of two physical downlink control channel monitoring spans, Y is a maximum length of a physical downlink control channel monitoring span in terms of OFDM symbols, and μ is subcarrier spacing; and
determine a maximum value based on the one or more candidate values, the maximum value being either:
a maximum number of non-overlapping Control Channel Elements, CCEs, for channel estimation per physical downlink control channel monitoring span; or
a maximum number of blind decodes for physical downlink control channel monitoring per physical downlink control channel monitoring span.

23-26. (canceled)
